(19) United States
(12) Patent Application Publication
(10) Pub. No.: US 2003/0208572 A1
(43) Pub. Date: Nov. 6, 2003

(54) Mechanism for reporting topology changes to clients in a cluster

(76) Inventors: Rajesh R. Shah, Portland, OR (US); Bruce M. Schlobohm, Fremont, CA (US)

Correspondence Address: Rob D. Anderson, C/O BLAKELY, SOKOLOFF, TAYOR & ZAMAN LLP, 12400 Wilshire Boulevard, Seventh Floor, Los Angeles, CA, 90025, US

(21) Appl. No.: 09/942,608

(22) Filed: Aug. 31, 2001

(51) Int. Cl. G06F 15/16; G06F 15/173

(52) U.S. Cl. 709/223; 709/203

(57) ABSTRACT

A topology change notification mechanism is provided to notify topology changes in a subnet of a switched fabric including at least a host system, a target system and switches interconnected via links. Such a mechanism may be installed in a host system to allow a client at one of the host system and the target system to create and communicate a list of topology changes that are interesting to the client for topology change notifications; determining if a topology change occurred in the switched fabric is in the list of topology changes created by the interested client; and reporting a topology change event to the interested client if the topology change is in the list of topology changes created by the interested client.

### TECHNICAL FIELD

The present invention relates to data transfer interface technology in a data network, and more particularly, relates to a mechanism for reporting relevant topology changes to clients in a cluster.

### BACKGROUND

As high-speed and high-performance communications become necessary for many applications such as data warehousing, decision support, mail and messaging, and transaction processing applications, a clustering technology has been adopted to provide availability and scalability for these applications. A cluster is a group of one or more host systems (e.g., computers, servers and workstations), input/output (I/O) units which contain one or more I/O controllers (e.g. SCSI adapters, network adapters etc.) and switches that are linked together by an interconnection fabric to operate as a single data network to deliver high performance, low latency, and high reliability. Clustering offers three primary benefits: scalability, availability, and manageability. Scalability is obtained by allowing servers and/or workstations to work together and to allow additional services to be added for increased processing as needed. The cluster combines the processing power of all servers within the cluster to run a single logical application (such as a database server). Availability is obtained by allowing servers to “back each other up” in the case of failure. Likewise, manageability is obtained by allowing the cluster to be utilized as a single, unified computer resource, that is, the user sees the entire cluster (rather than any individual server) as the provider of services and applications.

Emerging network technologies for linking servers, workstations and network-connected storage devices within a cluster include InfiniBand™ and its predecessor, Next Generation I/O (NGIO) which have been recently developed by Intel Corp. and other companies to provide a standard-based I/O platform that uses a channel oriented, switched fabric and separate I/O channels to meet the growing needs of I/O reliability, scalability and performance on commercial high-volume servers, as set forth in the “Next Generation Input/Output (NGIO) Specification,” NGIO Forum on Jul. 20, 1999 and the “InfiniBand™ Architecture Specification,” the InfiniBand™ Trade Association on Oct. 24, 2000.

One major challenge to implementing clusters based on NGIO/InfiniBand technology is to ensure that data messages traverse reliably between given ports of a data transmitter (source node) and a data receiver (destination node), via one or more given transmission (redundant) links of a switched fabric data network. Typically, fabric-attached InfiniBand™ clients are free to pick the best of all available data paths between source and destination nodes. New data paths may be dynamically created as needed between existing clients when new links and/or switches are inserted in the switched fabric data network. Likewise, existing data paths may be broken when links or switches fail or are manually removed. Either situation, fabric-attached InfiniBand™ clients need to be made aware of the creation of new data paths or the destruction of existing data paths in the switched fabric data network.

Currently there are some mechanisms defined in the NGIO/InfiniBand™ architecture specification to allow InfiniBand™ clients to become aware of topology changes in the switched fabric data network. However, these currently defined mechanisms require the InfiniBand™ clients to do a lot of work and waste a lot of cluster bandwidth to filter out and discard topology changes that do not affect the clients. Moreover, there is no mechanism for InfiniBand™ clients to solely use for requesting notifications only for relevant topology changes.

Accordingly, there is a need for a more client friendly topology change notification mechanism to allow InfiniBand™ clients to easily become aware of dynamic topology changes, including, for example, the creation of new paths when links and switched are inserted into the switched fabric data network, and the destruction of existing data paths when links and switches are removed from the same switched fabric data network.

### BRIEF DESCRIPTION OF THE DRAWINGS

A more complete appreciation of exemplary embodiments of the present invention, and many of the attendant advantages of the present invention, will become readily apparent as the same becomes better understood by reference to the following detailed description when considered in conjunction with the accompanying drawings in which like reference symbols indicate the same or similar components, wherein:

FIG. 1 illustrates a simple data network having several interconnected nodes for data communications according to an embodiment of the present invention;

FIG. 2 illustrates another example data network having several nodes interconnected by corresponding links of a multi-stage switched fabric according to an embodiment of the present invention;

FIG. 3 illustrates an example packet of data messages transmitted from a source node (data transmitter) to a destination node (data receiver) in an example data network according to an embodiment of the present invention;

FIG. 4 illustrates an example InfiniBand™ Architecture (IBA) subnet including four (4) switches and four (4) channel adapters installed, for example, at respective host system and remote system (IO unit) according to an embodiment of the present invention;

FIG. 5 illustrates an example InfiniBand™ Architecture (IBA) subnet having new data paths created according to an embodiment of the present invention;

FIG. 6 illustrates an example IBA subnet manager having an example topology change notification mechanism incorporated therein according to an embodiment of the present invention;

FIG. 7 illustrates an example high-level flow control for an InfiniBand™ client to request for topology change notifications in an example IBA subnet according to an embodiment of the present invention;

FIG. 8 illustrates an example high-level flow control for an example IBA subnet manager to process dynamic topology changes in an example IBA subnet according to an embodiment of the present invention; and

FIG. 9 illustrates an example exchange of messages between the InfiniBand™ client requesting notification and the example IBA subnet manager generating topology change notifications in an example IBA subnet according to an embodiment of the present invention.

### DETAILED DESCRIPTION

The present invention is applicable for use with all types of data networks, I/O hardware adapters and chipsets, including follow-on chip designs which link together end stations such as computers, servers, peripherals, storage subsystems, and communication devices for data communications. Examples of such data networks may include a local area network (LAN), a wide area network (WAN), a campus area network (CAN), a metropolitan area network (MAN), a global area network (GAN), a wireless personal area network (WPAN), and a system area network (SAN), including newly developed computer networks using Next Generation I/O (NGIO), Future I/O (FIO), InfiniBand™ and Server Net and those networks including channel-based, switched fabric architectures which may become available as computer technology advances to provide scalable performance. LAN systems may include Ethernet, FDDI (Fiber Distributed Data Interface) Token Ring LAN, Asynchronous Transfer Mode (ATM) LAN, Fiber Channel, and Wireless LAN. However, for the sake of simplicity, discussions will concentrate mainly on a host system including one or more hardware fabric adapters for providing physical links for channel connections in a simple data network having several example nodes (e.g., computers, servers and I/O units) interconnected by corresponding links and switches, although the scope of the present invention is not limited thereto.

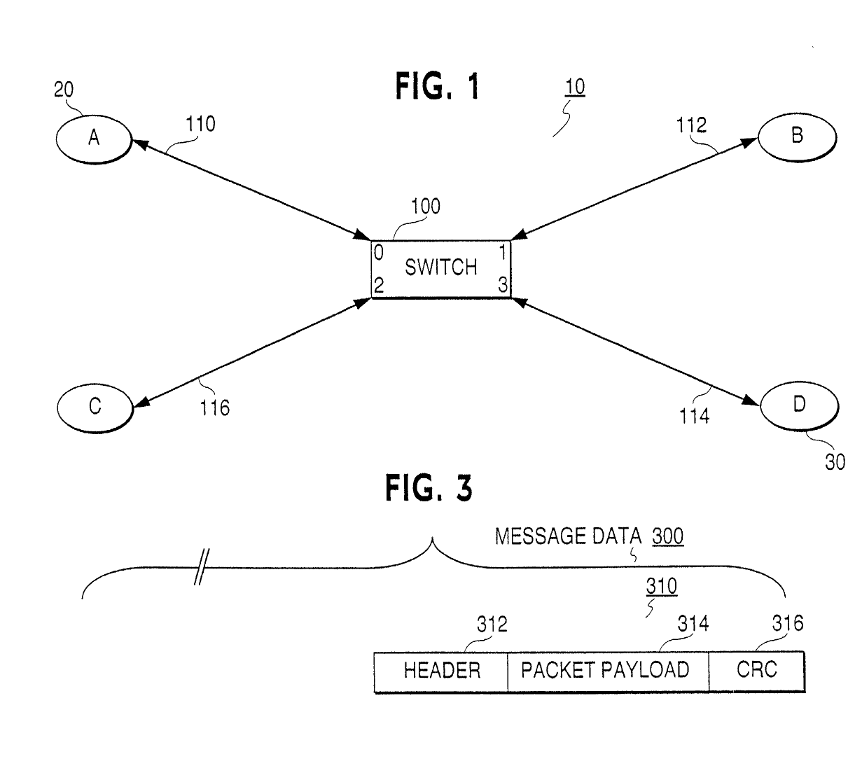

Attention now is directed to the drawings and particularly to FIG. 1, in which a simple data network 10 having several interconnected nodes for data communications according to an embodiment of the present invention is illustrated. As shown in FIG. 1, the data network 10 may include, for example, one or more centralized switches 100 and four different nodes A, B, C, and D. Each node (endpoint) may correspond to one or more I/O units and host systems including computers and/or servers on which a variety of applications or services are provided. I/O unit may include one or more processors, memory, one or more I/O controllers and other local I/O resources connected thereto, and can range in complexity from a single I/O device such as a local area network (LAN) adapter to large memory rich RAID subsystem. Each I/O controller (IOC) provides an I/O service or I/O function, and may operate to control one or more I/O devices such as storage devices (e.g., hard disk drive and tape drive) locally or remotely via a local area network (LAN) or a wide area network (WAN), for example.

The centralized switch 100 may contain, for example, switch ports 0, 1, 2, and 3 each connected to a corresponding node of the four different nodes A, B, C, and D via a corresponding physical link 110, 112, 116, and 114. Each physical link may support a number of logical point-to-point channels. Each channel may be a bi-directional data path for allowing commands and data messages to flow between two connected nodes (e.g., host systems, switch/switch elements, and I/O units) within the network.

Each channel may refer to a single point-to-point connection where data may be transferred between end nodes (e.g., host systems and I/O units). The centralized switch 100 may also contain routing information using, for example, explicit routing and/or destination address routing for routing data from a source node (data transmitter) to a target node (data receiver) via corresponding link(s), and re-routing information for redundancy.

The specific number and configuration of end nodes (e.g., host systems and I/O units), switches and links shown in FIG. 1 is provided simply as an example data network. A wide variety of implementations and arrangements of a number of end nodes (e.g., host systems and I/O units), switches and links in all types of data networks may be possible.

According to an example embodiment or implementation, the end nodes (e.g., host systems and I/O units) of the example data network shown in FIG. 1 may be compatible with the “Next Generation Input/Output (NGIO) Specification” as set forth by the NGIO Forum on Jul. 20, 1999, and the “InfiniBand™ Architecture Specification” as set forth by the InfiniBand™ Trade Association on Oct. 24, 2000. According to the NGIO/InfiniBand™ Specification, the switch 100 may be an NGIO/InfiniBand™ switched fabric (e.g., collection of links, routers, switches and/or switch elements connecting a number of host systems and I/O units), and the end node may be a host system including one or more host channel adapters (HCAs), or a remote system such as an I/O unit including one or more target channel adapters (TCAs). Both the host channel adapter (HCA) and the target channel adapter (TCA) may be broadly considered as fabric (channel) adapters provided to interface end nodes to the NGIO/InfiniBand™ switched fabric, and may be implemented in compliance with “Next Generation I/O Link Architecture Specification: HCA Specification, Revision 1.0”, and the “InfiniBand™ Specification” and the “InfiniBand™ Link Specification” for enabling the end nodes (endpoints) to communicate to each other over an NGIO/InfiniBand™ channel(s) with minimum data transfer rates, for example, up to 2.5 gigabit per second (Gbps).

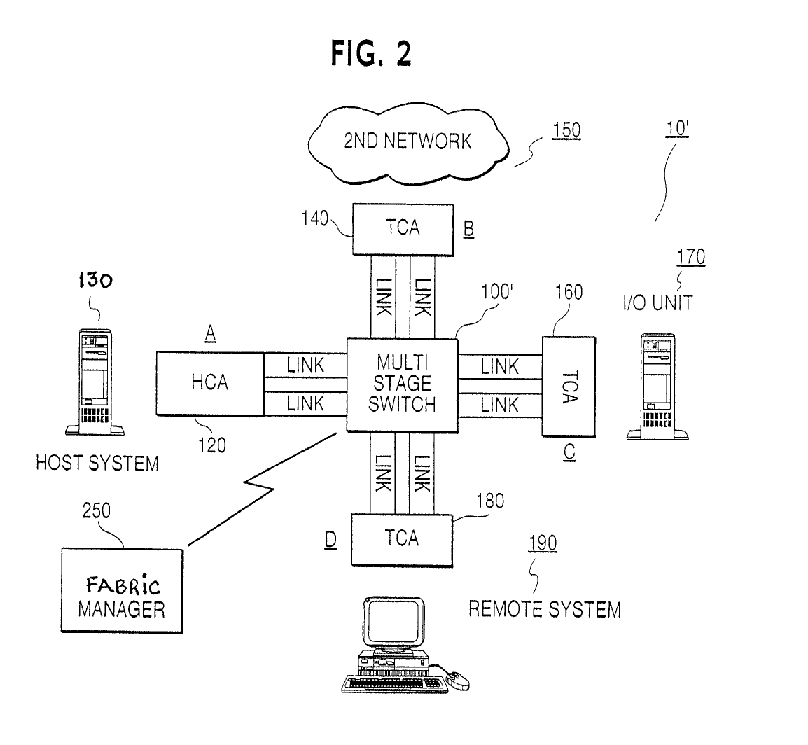

For example, FIG. 2 illustrates an example data network (i.e., system area network SAN) 10′ using an NGIO/InfiniBand™ architecture to transfer message data from a source node to a destination node according to an embodiment of the present invention. As shown in FIG. 2, the data network 10′ includes an NGIO/InfiniBand™ switched fabric 100′ for allowing a host system and a remote system to communicate to a large number of other host systems and remote systems over one or more designated channels. A channel connection is simply an abstraction that is established over a switched fabric 100′ to allow work queue pairs (WQPs) at source and destination end nodes (e.g., host and remote systems, and IO units that are connected to the switched fabric 100′) to communicate to each other. Each channel can support one of several different connection semantics. Physically, a channel may be bound to a hardware port of a host system. Each channel may be acknowledged or unacknowledged. Acknowledged channels may provide reliable transmission of messages and data as well as information about errors detected at the remote end of the channel. Typically, a single channel between the host system and any one of the remote systems may be sufficient but data transfer spread between adjacent ports can decrease latency and increase bandwidth. Therefore, separate channels for separate control flow and data flow may be desired. For example, one channel may be created for sending request and reply messages. A separate channel or set of channels may be created for moving data between the host system and any one of the remote systems. In addition, any number of end nodes or end stations, switches and links may be used for relaying data in groups of packets between the end stations and switches via corresponding NGIO/InfiniBand™ links. A link can be a copper cable, an optical cable, or printed circuit wiring on a backplane used to interconnect switches, routers, repeaters and channel adapters (CAs) forming the NGIO/InfiniBand™ switched fabric 100′.

For example, node A may represent a host system 130 such as a host computer or a host server on which a variety of applications or services are provided. Similarly, node B may represent another network 150, including, but may not be limited to, local area network (LAN), wide area network (WAN), Ethernet, ATM and fibre channel network, that is connected via high speed serial links. Node C may represent an I/O unit 170, including one or more I/O controllers and I/O units connected thereto. Likewise, node D may represent a remote system 190 such as a target computer or a target server on which a variety of applications or services are provided. Alternatively, nodes A, B, C, and D may also represent individual switches of the NGIO/InfiniBand™ switched fabric 100′ which serve as intermediate nodes between the host system 130 and the remote systems 150, 170 and 190.

Host channel adapter (HCA) 120 may be used to provide an interface between a memory controller (not shown) of the host system 130 (e.g., servers) and a switched fabric 100′ via high speed serial NGIO/InfiniBand™ links. Similarly, target channel adapters (TCA) 140 and 160 may be used to provide an interface between the multi-stage switched fabric 100′ and an I/O controller (e.g., storage and networking devices) of either a second network 150 or an I/O unit 170 via high speed serial NGIO/InfiniBand™ links. Separately, another target channel adapter (TCA) 180 may be used to provide an interface between a memory controller (not shown) of the remote system 190 and the switched fabric 100′ via high speed serial NGIO/InfiniBand™ links. Both the host channel adapter (HCA) and the target channel adapter (TCA) may be broadly considered as channel adapters (CAs) (also known as fabric adapters) provided to interface either the host system 130 or any one of the remote systems 150, 170 and 190 to the switched fabric 100′, and may be implemented in compliance with “Next Generation I/O Link Architecture Specification: HCA Specification, Revision 1.0” and the “InfiniBand™ Architecture Specification” for enabling the end nodes (endpoints) to communicate on one or more an NGIO/InfiniBand™ link(s). Individual channel adapters (CAs) and switches may have one or more connection points known as ports for establishing one or more connection links between end nodes (e.g., host systems and I/O units).

The multi-stage switched fabric 100′ may include one or more subnets interconnected by routers in which each subnet is composed of switches, routers and end nodes (such as host systems or I/O subsystems). In addition, the multi-stage switched fabric 100′ may include a fabric manager 250 connected to all the switches for managing all network management functions. However, the fabric manager 250 may alternatively be incorporated as part of either the host system 130, the second network 150, the I/O unit 170, or the remote system 190 for managing all network management functions.

If the multi-stage switched fabric 100′ represents a single subnet of switches, routers and end nodes (such as host systems or I/O subsystems) as shown in FIG. 2, then the fabric manager 250 may alternatively be known as a subnet manager “SM”. The fabric manager 250 may reside on a port of a switch, a router, or a channel adapter (CA) of an end node and can be implemented either in hardware or software. When there are multiple subnet managers “SMs” on a subnet, one subnet manager “SM” may serve as a master SM. The remaining subnet managers “SMs” may serve as standby SMs. The master SM may be responsible for (1) learning or discovering fabric (network) topology; (2) assigning unique addresses known as Local Identifiers (LID) to all ports that are connected to the subnet; (3) establishing all possible data paths among end nodes, via switch forwarding tables (forwarding database); and (4) detecting and managing faults or link failures in the network and performing other network management functions. However, NGIO/InfiniBand™ is merely one example embodiment or implementation of the present invention, and the invention is not limited thereto. Rather, the present invention may be applicable to a wide variety of any number of data networks, hosts and I/O units using industry specifications. For example, practice of the invention may also be made with Future Input/Output (FIO). FIO specifications have not yet been released, owing to subsequent merger agreement of NGIO and FIO factions combine efforts on InfiniBand™ Architecture specifications as set forth by the InfiniBand Trade Association (formed Aug. 27, 1999) having an Internet address of“http://www.InfiniBandta.org.”

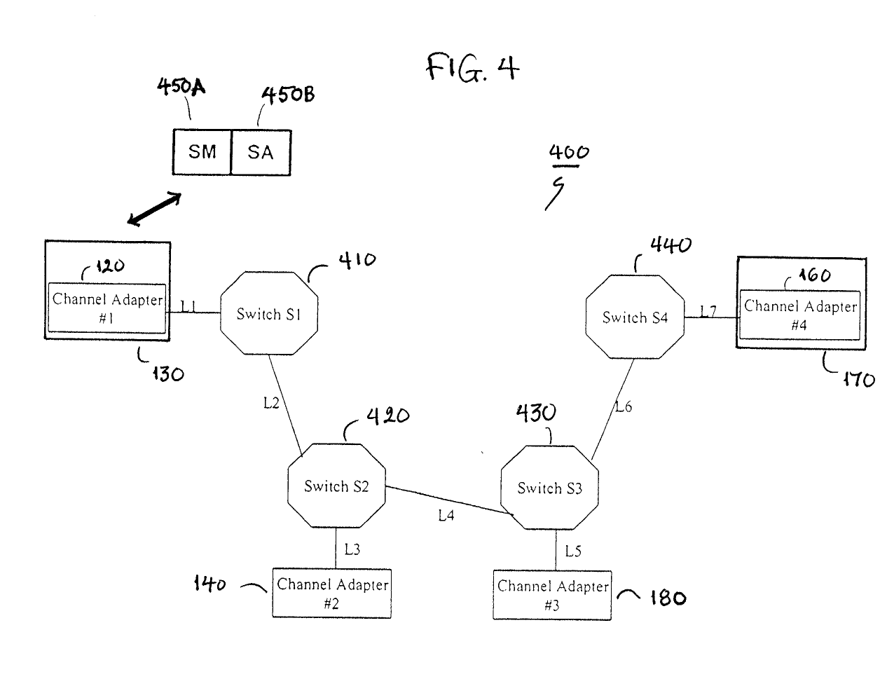

FIG. 3 illustrates an example packet format of message data transmitted from a source node (data transmitter) to a destination node (data receiver) through switches and/or intermediate nodes in an example IBA subnet according to the “InfiniBand™ Architecture Specification” as set forth by the InfiniBand™ Trade Association on Oct. 24, 2000. As shown in FIG. 3, a message data 300 may represent a sequence of one or more data packets 310 (typically derived from data transfer size defined by a work request). Each packet 310 may include header information 312, variable format packet payload 314 and cyclic redundancy check (CRC) information 316. Under the “Next Generation Input/Output (NGIO) Specification” as previously set forth by the NGIO Forum on Jul. 20, 1999, the same data packets may be referred to as data cells having similar header information as the least common denominator (LCD) of message data. However, NGIO header information may be less inclusive than InfiniBand™ header information. Nevertheless, for purposes of this disclosure, data packets are described herein below via InfiniBand™ protocols but are also interchangeable with data cells via NGIO protocols.

The header information 312 according to the InfiniBand™ specification may include, for example, a local routing header, a global routing header, a base transport header and extended transport headers each of which contains functions as specified pursuant to the “InfiniBand™ Architecture Specification”. For example, the local routing header may contain fields such as a destination local identifier (LID) field used to identify the destination port and data path in the data network 10′, and a source local identifier (LID) field used to identify the source port (injection point) used for local routing by switches within the example data network 10′ shown in FIG. 2.

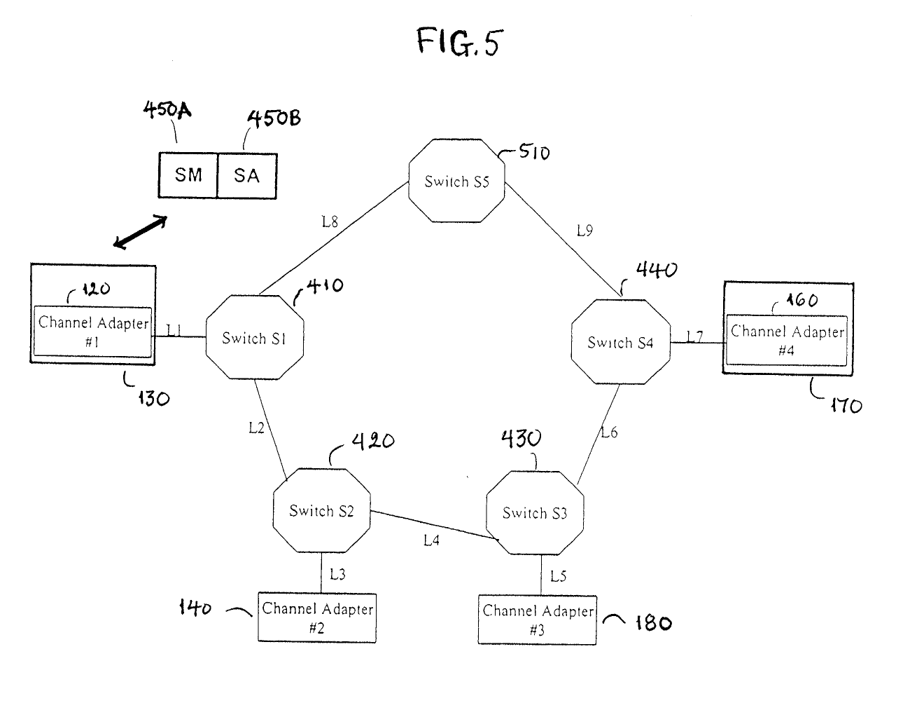

FIG. 4 illustrates an example InfiniBand™ Architecture (IBA) subnet including, for example, four (4) switches and four (4) channel adapters (CAs) according to an embodiment of the present invention. Channel adapters #1, #2, #3 and #4 120, 140, 160 and 180 may be installed, for example, at the host system 130, the second network 150, the IO unit 170 and the remote system 190 as shown in FIG. 2. The IBA subnet 400 may include a collection of switch (S1) 410, switch (S2) 420, switch (S3) 430 and switch (S4) 440 arranged to establish connection between the host system 130, via a channel adapter (CA1) 120 and the remote I/O unit 170, via a channel adapter (CA4) 160. Each switch as well as the channel adapter (CA) may have one or more connection points called “ports” provided to establish connection with every other switch and channel adapter (CA) in an example IBA subnet 400 via one or more link.

Typically IBA management services may be provided by a local subnet manager “SM” 450A and a local subnet administrator “SA” 450B. The subnet manager “SM” 450A and the subnet administrator “SA” 450B may substitute the fabric manager 250 shown in FIG. 2, and can be implemented either in hardware or software module (i.e., an application program) installed to provide IBA management services for all switches and end nodes in the IBA subnet 400. For example, if the subnet manager “SM” 450A is implemented in software, a subnet management software module may be written using high-level programming languages such as C, C++ and Visual Basic, and may be provided on a computer tangible medium, such as memory devices; magnetic disks (fixed, floppy, and removable); other magnetic media such as magnetic tapes; optical media such as CD-ROM disks, or via Internet downloads, which may be available for a human subnet (fabric) administrator to conveniently plug-in or download into an existing operating system (OS). Alternatively, the software module may also be bundled with the existing operating system (OS) which may be activated by a particular device driver for performing all network management functions in compliance with the InfiniBand™ Architecture specification.

The management services may be broadly classified into subnet services and general services. At a minimum the subnet services, offered by the subnet manager “SM” 450A, include discovering fabric topology, assigning unique addresses called Local Identifiers (LID) to all ports that are connected to the IBA subnet 400, programming switch forwarding tables (also known as routing table) and maintaining general functioning of the IBA subnet 400. Most of the data collected during discovery and used to configure the IBA subnet 400 may be assimilated by the subnet administrator “SA” 450B for providing access to information such as alternate data paths between end nodes, and notification of events, including error detection, recovery procedures and notification.

In one embodiment of the present invention, both the subnet manager “SM” 450A and the subnet administrator “SA” 450B may be installed at the host system 130 for managing all subnet management functions. However, the subnet manager “SM” 450A and the subnet administrator “SA” 450B may also be installed as part of any individual end node and switch within the IBA subnet 400.

In a simple example IBA subnet 400 as shown in FIG. 4, there is exactly one data path between a client running on CA1 120 and a client running on CA4 160. This data path may traverse switches S1 410, S2 420, S3 430 and S4 440 and links L1, L2, L4, L6 and L7. A subnet administrator (not shown) may notice that there is a large amount of traffic between CA1 120 and CA4 160. In this example IBA subnet 400, the existing data path between the two channel adapters CA1 120 and CA4 160 may not be sufficient to handle the traffic well. In this situation, the subnet administrator (not shown) should have the ability to create new data paths between channel adapters CA1 120 and CA4 160 by inserting new links and/or switches. Further, existing clients running on channel adapters CA1 120 and CA4 160 need to become aware of the existence of a new data path so that they can start using the new (better) path instead of or in addition to the one they are currently using.

FIG. 5 illustrates new data paths created in the example IBA subnet 400 shown in FIG. 4. Specifically, a new switch S5 510 and links L8, L9 have been inserted in the example IBA subnet 400. There is now at least one new data path created between IBA clients on channel adapters CA1 120 and CA4 160. This new data path may have better performance characteristics than the data path being already used by the client pair on channel adapters CA1 120 and CA4 160.

Just like link/switch insertions affect data paths existing client pairs, link/switch removal may also affect data paths between existing client pairs. Existing data paths can be broken when links or switches fail or are manually removed. Some clients may notice the problem right away because they are actively using the broken data paths. However, some clients in the IBA subnet 400 or the switched fabric 100′ actively using the paths may use unreliable datagrams i.e., a messaging scheme defined by the InfiniBand™ Architecture specification that does not provide any delivery guarantees and does not provide feedback about whether the message from sender made it successfully to the recipient. These clients may spend considerable time retrying messages before concluding that the data path is broken and attempt to use an alternate data path. Yet other clients may not be actively using the broken data paths but may be keeping the broken data paths as alternate data paths to be used only if the primary data path fails. Therefore, it is desirable that the clients identify other available alternate paths before the primary data path fails and unsuccessful attempts to use non-existent alternate data paths are made. Clients need to be aware of dynamic topology changes in the IBA subnet 400. However, there are a number of problems that need to be solved before a subnet manager “SM” 450A can react appropriately when dynamic topology changes occur. For example:

First, the subnet manager “SM” 450A has to be able to detect newly inserted or removed switches/links.

Second, if new data paths are created due to link/switch insertion, the subnet manager “SM” 450A should be able to configure newly created data paths into the IBA subnet 400 in terms of new LIDs assigned to the affected end nodes. There are several ways in which this problem can be solved. One example is that the subnet manager (SM) 450A can reserve LIDs for ports during subnet initialization in anticipation of new data paths being created in future.

Third, affected clients need to be made aware of the fact that new data paths were created or existing data paths were destroyed. There are some mechanisms currently defined in the InfiniBand™ Architecture specification to address this need but these mechanisms are not client friendly or subnet friendly. For instance, the InfiniBand™ Architecture specification defines optional traps that can be generated when dynamic topology changes such as link insertion or removal occur. Interested clients can use the InformInfo attribute as defined by the InfiniBand™ Architecture specification to subscribe to these traps and request that these events should be forwarded to them when these events occur. However, there are two fundamental problems with client using the trap subscription/event forwarding mechanism as defined in the InfiniBand™ Architecture specification to become aware of topology changes: 1) Generating traps for topology changes is optional. If no traps are generated, there is nothing for clients to subscribe to and they are not notified of topology changes; and 2) Even if these traps are generated, there is no filter mechanism that clients can use to request notification only for topology changes that are interesting to the clients.

As defined in the InfiniBand™ Architecture specification, an interested client can subscribe for traps generated by a specific GID (a global identifier used by applications to address a multicast group and route packets between IBA subnets as opposed to a local identifier “LID” used to switch packets within an IBA subnet 400) or traps generated by a range of channel adapter (CA) or switch LID addresses. However, a client running on an end node does not and should not need to know the GIDs or LIDs of all current and future InfiniBand components on the IBA subnet 400 that could generate traps it is interested in. This makes it difficult for clients to subscribe to traps based on GIDs or LID ranges.

In addition, the InfiniBand™ Architecture specification also defines a special value that clients can use to request trap forwarding from all LIDs assigned to switches or channel adapters (CA). A client may use this feature to subscribe to all topology change traps generated by all switch LIDs (and channel adapter LIDs if appropriate) without needing to know specific GIDs or LID ranges. However, this is inefficient and requires the client to process and discard traps that do not indicate a topology change that specifically affects the client node. For example, a host system 130 may only be interested in being notified when new data paths are created or destroyed to its I/O controller (i.e. target channel adapter “TCA”). The same host system 130 does not care about new data paths created between some other client pair on the IBA subnet 400 or the switch fabric 100′ (see FIG. 2). To detect new data paths using the currently defined raw trap subscription mechanism, the I/O controller driver of the host system 130 would have to subscribe to all traps from all switch LIDs in the IBA subnet 400 (new data paths could be created with no trap being generated by the target channel adapter “TCA”). A link insertion event in an unrelated switch that does not affect the host system 130 will still be reported to the host system 130. The exact same situation applies to all clients on the IBA subnet 400.

As a result, any client that wants to detect new data paths would be forced to subscribe to all topology change traps from all switches. Once the trap notice arrives, each client would have to take follow up action to determine if it is impacted by this change. For example, each client may have to send follow-up queries to the subnet administrator database for all possible path records between the client pair and compare with the current known data paths to determine if a new data path was created. Apart from wasting client's time and introducing unnecessary complexity, such blanket trap subscription wastes cluster bandwidth and ties up resources like the path query service in the subnet administrator “SA” 450B. Most of the intelligence (and work) to determine the impact of switch/link insertions has to be replicated at every client. For these reasons, the raw trap subscription mechanism defined in the InfiniBand™ Architecture specification is not client friendly or subnet friendly.

In order to address several problems with the raw trap subscription mechanism currently defined by the InfiniBand™ Architecture specification, an especially designed topology change notification mechanism may be incorporated into the subnet manager “SM” 450A to simplify the procedure InfiniBand clients have to use to become aware of relevant topology changes like the creation or destruction of data paths when links and switches are inserted or removed. If the subnet manager “SM” 450A is implemented in software, the topology change notification mechanism may be incorporated into the subnet management software to allow clients to request for notification only if a topology change that impacts the clients occurs.

More specifically, clients should be able to set filters that define what topology changes they are interested in. Each physical topology change may then be compared to client-defined filters. A client may be notified of the topology change only if the same client requests notification for this topology change. Clients that are not impacted by the topology change are not perturbed and events that do not indicate relevant topology changes are not reported to clients. Since most of the work to determine the impact of switch/link insertions is done in a single place—by the subnet management software, the topology change notification can be simplified immensely and the cluster bandwidth can be reduced.

The topology change notification mechanism may assign the following additional responsibility to subnet management software to perform the following:

1) The subnet management software should define client friendly filters that clients can use to request notification only for events that are interesting to the client. Examples of client friendly filters include, but are not limited to:

a) Notify the client when a new data path is created between a pair of endpoints or end nodes as specified by a pair of InfiniBand™ defined GUIDs (global unique identifier assigned by the CA vendor for identification). Each of the endpoint specified by the client can be either a port (as specified by a port GUID), or a channel adapter node (as specified by a node GUID) or an enclosure (as specified by the enclosure GUID like Chassis GUID). The subnet management software may allow mixing and matching of the type of endpoint specified. For example, one client may specify port GUIDs for both end points or end nodes. Another client may specify a port GUID for one endpoint and a node (or Chassis) GUID for the other end point. An example of a client that can benefit from this feature is the host side driver for a fabric-attached I/O controller. This driver may request notification when a new data path is created between the host system 130 it is running on (as specified by Chassis GUID) and the remote channel adapter (CA) on which the target I/O controller is running (as specified by the remote node GUID).

b) Notify the client when an existing data path is destroyed between a pair of endpoints or end nodes as specified by a pair of InfiniBand defined GUIDs or LIDs. Each of the endpoint specified by the client can be either a LID, or a port (as specified by a port GUID), or a channel adapter node (as specified by a node GUID) or an enclosure (as specified by the enclosure GUID like Chassis GUID). The subnet management software may allow mixing and matching of the type of end point specified. For example, one client may specify port GUIDs for both end points. Another client may specify a port GUID for one endpoint and a node (or Chassis) GUID for the other end point. An example of a client that can benefit from this feature is the host side driver for a fabric-attached I/O controller. This driver may be keeping an alternate data path to be used if the primary data path fails. It may specify a pair of LIDs representing the alternate data path and request notification when this data path breaks.

c) Notify the client when a new InfiniBand device type (e.g. channel adapter or switch) is inserted in the IBA subnet 400 or the switched fabric 100′. An example of a client that can benefit from this feature is an Ethernet LAN emulation driver that is running on a switched fabric 100′ that does not support multicast (or broadcast). Such a driver might want to become aware of any new channel adapter that is inserted in the switched fabric 100′ so that a TCP/IP connectivity can be established. Another example is a fabric GUI that is displaying information about all fabric-attached devices and needs to know whenever a new switch or channel adapter (CA) is inserted so the GUI view can be updated to display the new arrival.

d) Notify the client when an InfiniBand device type (e.g. channel adapter “CA” or switch) is removed from the IBA subnet 400 or the switched fabric 100′. An example of a client that can benefit from this feature is an Ethernet LAN emulation driver that is running on an IBA subnet 400 or a switched fabric 100′ that does not support multicast (or broadcast). Such a driver might want to know when a channel adapter “CA” during communication has gone away. This is especially important if unreliable datagram messages are used for communications. In this instance, in the absence of the notification, the client driver may have to wait for a long time and implement a large number of retries before it concludes that the remote channel adapter “TCA” has been removed or is not reachable using any data path through the IBA subnet 400 or the switched fabric 100′.

It should be noted that the list above is just representative of the type of client friendly notification filters that can be provided by subnet management software. Additional notification filters can be provided as appropriate.

2) The subnet management software should also provide the notifications as indicated to interested clients regardless of how subnet management software became aware of the topology change in the IBA subnet 400 or the switched fabric 100′. For example, when new switches and links are inserted to create a new data path, it is possible that no traps are generated or that traps are generated but lost. In this case, the subnet management software may become aware of the topology changes only when it sweeps the IBA subnet 400 or the switched fabric 100′. The topology change notification mechanism requires the notification to be sent in this situation also, which is different from what is specified in the InfiniBand™ architecture specification of event forwarding where a notification may be generated only if there is a corresponding trap.

3) A wire level protocol should be defined so that messages could be exchanged between clients requesting the use of this feature and the subnet management software implementing the protocol. A message level protocol may define how this feature capability is discovered, class and attributes of the messages exchanged, how the messages are acknowledged and retried etc. One possible implementation solution may require using vendor specific management datagrams “MADS” for this purpose. In this case, a requesting client may send a MAD to the subnet manager address with class value set to VendorSpecific, method value set to VendorSet and attribute ID set to a newly defined value SetNotificationFilter. There may be a well-defined payload field that allows the client to describe the filter during setting. The request may be acknowledged by using a reply MAD with method value set to VendorGetResp. If no confirmation comes back, the request may be resent till the response arrives or the client times out. For sending a notification to the client when a relevant event occurs, the subnet administrator “SA” 450B may send a MAD with class value set to VendorSpecific, method value set to VendorSend and attribute ID set to a newly defined value TopologyChangeNotification. The data portion of the MAD may describe what the event was. The recipient may then acknowledge the notification with a MAD with method value set to VendorSendResp. There may be several possible modifications that can be made to the procedure specified above (e.g. no retries or a fixed number of retries by the subnet management software when sending notifications). In addition, there are other possible ways of implementing this support apart from using vendor specific MADs.

The topology change notification implementation may also require storing client notification filters and making them available to standby subnet managers “SMs” to ensure that topology change notifications can continue without a client having to re-register if a standby subnet manager “SM” becomes the primary. Client set filters may need to be inspected by the standby subnet manager “SM” for notification when dynamic topology changes are detected at the subnet manager “SM” 450A.

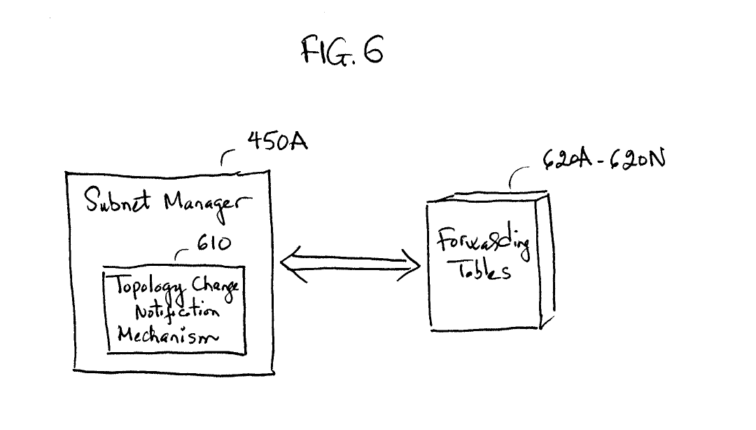

FIG. 6 illustrates an example topology change notification mechanism implementation according to an embodiment of the present invention. As shown in FIG. 6, the topology change notification mechanism 610 may be incorporated into the subnet manager “SM” 450A as shown in FIG. 4 to allow a client to create a list of topology changes that are interesting to the client in a form of notification filters specific to the client during, for example, registration, and to report topology change notifications to interested clients when a topology change in the created list occur. In addition to the functionality of the topology change notification, the subnet manager “SM” 450A may also be responsible for discovering the topology, assigning unique addresses called Local Identifiers (LID) to all ports that are connected to the IBA subnet 400, and establishing possible data paths among all ports by programing switch forwarding tables (also known as routing table) for download to the switches, for example, switch (S1) 410, switch (S2) 420, switch (S3) 430 and switch (S4) 440 in the example IBA subnet 400 for routing data packets to destinations via possible data paths established between switch pairs. For example, if the IBA subnet 400 has four (4) switches as shown in FIG. 4, then the subnet manager “SM” 450A may build four (4) forwarding tables 620A-620N for all four (4) switches respectively, and download the respective forwarding table into respective switch after the topology discovery. Such forwarding tables 620A-620N may be computed to determine data paths between switch pairs in the IBA subnet 400 and may be constantly updated to reflect any dynamic changes to the subnet topology.

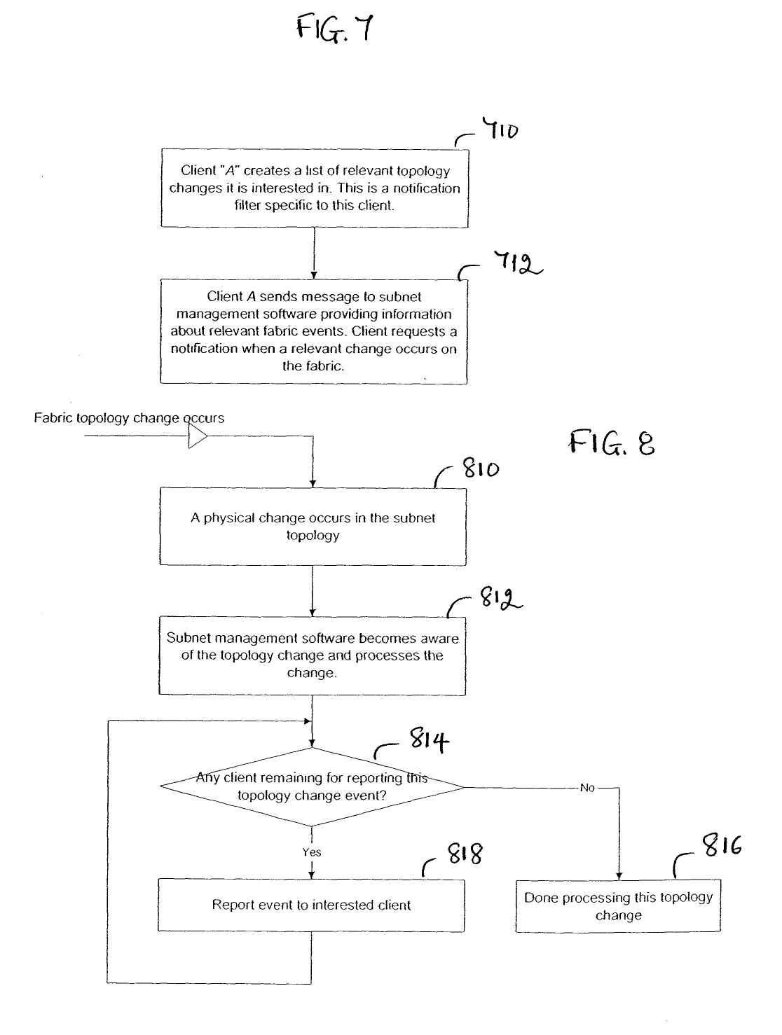

FIG. 7 illustrates an example high-level flow control for an InfiniBand™ client to request for topology change notifications in an example IBA subnet 400 according to an embodiment of the present invention. As shown in FIG. 7, the client “A” at a host system 130, for example, may create a list of topology changes that are interesting to the client at any given time at block 710. The list of topology changes may include, for example: when a new data path is created between a pair of end-points or end nodes in an IBA subnet 400 (or a switched fabric 100′), when an existing data path is destroyed between a pair of end-points or end nodes in the IBA subnet 400 (or the switched fabric 100′), when a new InfiniBand™ device is inserted in the IBA subnet 400 (or the switched fabric 100′), and when the InfiniBand™ device is removed from the IBA subnet 400 (or the switched fabric 100′). The topology changes in the list are client-defined filters that a client can use to request notification only for relevant fabric events specific to the client.

After the client has created its notification filters, the same client “A” at the host system 130 may then send a message back to the subnet manager “SM” 450A, and request the subnet manager “SM” 450A for notification when a relevant topology change occurs in the IBA subnet 400 (or the switched fabric 100′) at block 712.

FIG. 8 illustrates an example high-level flow control for an example IBA subnet manager “SM” 450 to process dynamic topology changes in an example IBA subnet 400 according to an embodiment of the present invention. When there is an occurrence of a fabric topology change, i.e., when a new data path is dynamically created, an existing data path is dynamically destroyed, or a new IBA device is inserted or removed from the switched fabric 100′, a physical change also occurs in the subnet topology at block 810. The subnet manager “SM” 450A becomes aware of the topology change and processes the topology change accordingly at block 812. The subnet manager “SM” 450A next determines if the topology change is one that a client requested for notification, i.e., if any client remaining for reporting the topology change event at block 814. In other words, the subnet manager “SM” 450A checks if notifications for topology changes have to be provided to interested clients. Each physical topology change may be compared to client-defined filters as described with reference to FIG. 7 to determine if the topology change is one that an interested client requested for notification. For example, if the physical topology change does not correspond to any of the client-defined filters, then the clients are not perturbed and the topology change event is not reported to the clients. However, if the physical topology change corresponds to any of the client-defined filters, then the clients need to be notified of the relevant topology change.

If the topology change is not one that a client requested for notification, the subnet manager “SM” 450A is done with processing the topology change at block 816. However, if the topology change is one that a client requested for notification, the subnet manager “SM” 450A may then report the topology change event to the interested client at block 818.

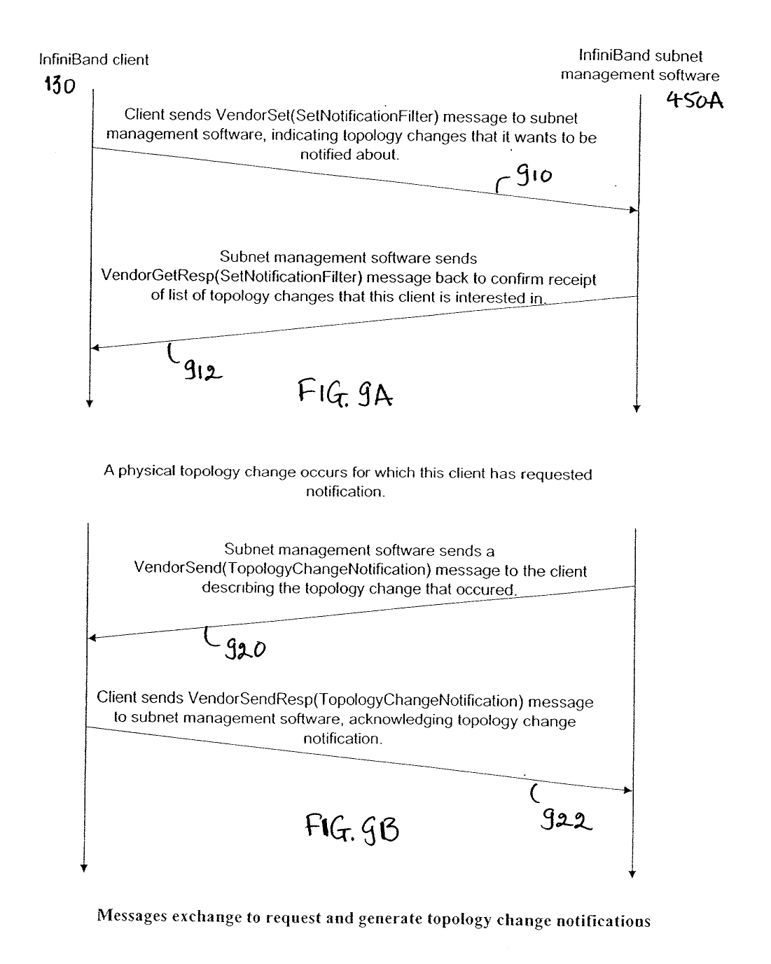

FIGS. 9A-9B illustrate an example exchange of messages between the InfiniBand™ client requesting notification and the example IBA subnet manager “SM” 450A generating topology change notifications in an example IBA subnet 400 according to an embodiment of the present invention. More specifically, FIG. 9A illustrates an example exchange of messages between the InfiniBand™ client and the example IBA subnet manager “SM” 450A during a request for topology change notification. After the list of relevant topology changes has been created as described with reference to FIG. 7, the client “A” at a host system 130, for example, may send a VendorSet (SetNotificationFilter) message 910 to the subnet manager “SM” 450A indicating topology changes that the client “A” wants to be notified.

Upon receipt of the VendorSet (SetNotificationFilter) message 910 from the client “A” at the host system 130, the subnet manager “SM” 450A may send a VendorGetResp (SetNotificationFilter) message 912 back to the client “A” at the host system 130 to confirm receipt of the list of topology changes that the client “A” is interested in.

Likewise, FIG. 9B illustrates an example exchange of messages between the InfiniBand™ client and the example IBA subnet manager “SM” 450A when a topology change occurs in accordance with the client-defined filters. After the physical topology change has occurred in accordance with the client-defined filters as described with reference to FIG. 8, the subnet manager “SM” 450A may send a VendorSend (TopologyChangeNotification) message 920 to the interested client, for example, client “A” at the host system 130 describing the topology change that occurred.

Upon receipt of the VendorSend (TopologyChangeNotification) message 920 from the subnet manager “SM” 450A, the client “A” at the host system 130, for example, may send a VendorSendResp (TopologyChangeNotification) message 922 back to the subnet manager “SM” 450A to acknowledge receipt of the topology change notification.

As described from the foregoing, the present invention advantageously provides a topology change notification mechanism that allows the subnet manager “SM” 450A to detect dynamic topology changes in an IBA subnet 400 and make an appropriate topology change notification accordingly. Currently defined InfiniBand™ specification mechanisms require interested clients to incorporate all the intelligence and do all the hard work to check the relevancy of dynamic subnet topology changes and require the notification process to be replicated in all the clients with greater complexity. In addition, currently defined InfiniBand™ specification mechanisms also require a significant wastage in cluster resources and bandwidth. For example, if each client is responsible for checking whether a topology change impacts it or not, each client will have to issue a large number of request to the subnet administrator “SA” 450B. This ties up cluster bandwidth wastefully and has the potential of bogging down the subnet administrator “SA” 450B in doing wasteful work. In contrast to currently defined InfiniBand™ specification mechanisms, the topology change notification mechanism according to an embodiment of the present invention advantageously allows the IBA subnet to be much more client friendly in terms of the ability to dynamically create new and better data paths as needed, and the ability to significantly reduce wasteful usage of cluster bandwidth and resources. These properties assist in achieving the end result of a functional and high performance cluster and promote the use of clusters based on NGIO/InfiniBand™ technology.

While there have been illustrated and described what are considered to be exemplary embodiments of the present invention, it will be understood by those skilled in the art and as technology develops that various changes and modifications may be made, and equivalents may be substituted for elements thereof without departing from the true scope of the present invention. For example, the data network as shown in FIGS. 1-4 may be configured differently or employ some or different components than those illustrated. Such a data network may include a local area network (LAN), a wide area network (WAN), a campus area network (CAN), a metropolitan area network (MAN), a global area network (GAN) and a system area network (SAN), including newly developed computer networks using Next Generation I/O (NGIO) and Future I/O (FIO) and Server Net and those networks which may become available as computer technology advances in the future. LAN system may include Ethernet, FDDI (Fiber Distributed Data Interface) Token Ring LAN, Asynchronous Transfer Mode (ATM) LAN, Fiber Channel, and Wireless LAN. In addition, the subnet manager “SM” and the subnet administrator “SA” may be integrated and installed at any node of the IBA subnet. The topology change notification mechanism shown in FIG. 6 may be configured differently or employ some or different components than those illustrated without changing the basic function of the invention. Many modifications may be made to adapt the teachings of the present invention to a particular situation without departing from the scope thereof. Therefore, it is intended that the present invention not be limited to the various exemplary embodiments disclosed, but that the present invention includes all embodiments falling within the scope of the appended claims.

What is claimed is:

1. A method for reporting topology changes in a subnet of a switched fabric including at least a client, a subnet manager (SM) and switches interconnected via links, said method comprising:
creating and reporting a list of topology changes that are interesting to the client for topology change notifications;
when a topology change occurs in the subnet, determining if the topology change is in the list of topology changes created by the interested client; and
if the topology change is in the list of topology changes created by the interested client, reporting a topology change event to the interested client.

2. The method as claimed in claim 1, wherein said list of topology changes is created by the client to serve as client-defined filters that specify the types of topology changes the client is interested in receiving notifications.

3. The method as claimed in claim 2, wherein said list of topology changes includes, but is not limited to, when a new data path is created between a pair of end nodes in the subnet, when an existing data path is destroyed between a pair of end nodes in the subnet, when a new device is inserted in the subnet, and when an existing device is removed from the subnet.

4. The method as claimed in claim 1, wherein said client corresponds to an end node of the subnet having at least one channel adapter (CA) installed to support one or more ports for data communication via said links of the subnet.

5. The method as claimed in claim 2, wherein said determining the topology change in the list of topology changes and said reporting the topology change events to the interested client are executed by said subnet manager.

6. The method as claimed in claim 5, wherein said subnet manager (SM) is installed in another end node of the subnet, and is implemented either in hardware or software to provide management services for all switches and end nodes in the subnet.

7. The method as claimed in claim 5, wherein said subnet manager (SM) is installed in another end node of the subnet, and is implemented in software written using a high-level computer programming language for performing network management functions in compliance with the InfiniBand™ Architecture specification.

8. The method as claimed in claim 5, wherein said subnet manager (SM) is installed in another end node of the subnet for discovering the subnet topology, assigning unique addresses to all ports that are connected to the subnet, and establishing possible data paths among all ports by programing switch forwarding tables for download to the switches in the subnet for routing data packets to destinations via possible data paths established between switch pairs.

9. The method as claimed in claim 1, wherein said client sends a VendorSet (SetNotificationFilter) message to the subnet manager (SM) after the list of topology changes is created to indicate the topology changes that require client notifications, and said subnet manager (SM) sends a VendorGetResp (SetNotificationFilter) message back to the interested client to confirm receipt of the list of topology changes that the client is interested.

10. The method as claimed in claim 1, wherein said subnet manager (SM) sends a VendorSend (TopologyChangeNotification) message to the interested client after the topology change is determined in the list of topology changes to notify the topology change that occurred, and said client sends a VendorSendResp (TopologyChangeNotification) message back to the subnet manager (SM) to acknowledge the topology change notification.

11. A data network, comprising:
a host system having at least one channel adapter (CA) installed therein supporting one or more ports;
at least one target system having at least one channel adapter (CA) installed therein supporting one or more ports;
a switched fabric comprising a plurality of different switches which interconnect said host system via CA ports to said remote system via CA port along different physical links for data communications; and
a fabric manager provided in said host system for making topology discovery, assigning local identifiers (LIDs) to all ports that are connected in the switched fabric, and programming forwarding tables for switches in the switched fabric, wherein said fabric manager includes a topology change notification mechanism configured to provide topology change notifications by:
enabling a client at one of the host system and the target system to create and communicate a list of topology changes that are interesting to the client for topology change notifications;
determining if a topology change occurred in the switched fabric is in the list of topology changes created by the interested client; and
if the topology change is in the list of topology changes created by the interested client, reporting a topology change event to the interested client.

12. The data network as claimed in claim 11, wherein said list of topology changes is created by the client to serve as client-defined filters that specify the types of topology changes the client is interested in receiving topology change notifications.

13. The data network as claimed in claim 12, wherein said list of topology changes includes, but is not limited to, when a new data path is created between a pair of end nodes in the switched fabric, when an existing data path is destroyed between a pair of end nodes in the switched fabric, when a new device is inserted in the switched fabric, and when an existing device is removed from the switched fabric.

14. The data network as claimed in claim 11, wherein said fabric manager is installed in another one of the host system and the target system, and is implemented either in hardware or software to provide management services for all switches and end nodes in the switched fabric.

15. The data network as claimed in claim 11, wherein said fabric manager is installed in another one of the host system and the target system, and is implemented in software written using a high-level computer programming language for performing network management functions in compliance with the InfiniBand™ Architecture specification.

16. The data network as claimed in claim 15, wherein said fabric manager is further configured to discover the fabric topology, assign unique addresses to all ports that are connected to the switched fabric, and establish possible data paths among all ports by programing switch forwarding tables for download to the switches in the switched fabric for routing data packets to destinations via possible data paths established between switch pairs.

17. The data network as claimed in claim 11, wherein said client sends a VendorSet (SetNotificationFilter) message to the fabric manager after the list of topology changes is created to indicate the topology changes that require client notifications, and said fabric manager sends a VendorGetResp (SetNotificationFilter) message back to the interested client to confirm receipt of the list of topology changes that the client is interested.

18. The data network as claimed in claim 11, wherein said fabric manager sends a VendorSend (TopologyChangeNotification) message to the interested client after the topology change is determined in the list of topology changes to notify the topology change that occurred, and said client sends a VendorSendResp (TopologyChangeNotification) message back to the fabric manager to acknowledge the topology change notification.

19. A computer readable medium comprising instructions that, when executed by a host system in a switched fabric including end nodes and switches interconnected via links, cause the host system to:
enabling a client at an end node to create and communicate a list of topology changes that are interesting to the client for topology change notifications;
determining if a topology change occurred in the switched fabric is in the list of topology changes created by the interested client; and
if the topology change is in the list of topology changes created by the interested client, reporting a topology change event to the interested client.

20. The computer readable medium as claimed in claim 19, wherein said list of topology changes is created by the client to serve as client-defined filters that specify the types of topology changes the client is interested in receiving topology change notifications.

21. The computer readable medium as claimed in claim 20, wherein said list of topology changes includes, but is not limited to, when a new data path is created between a pair of end nodes in the switched fabric, when an existing data path is destroyed between a pair of end nodes in the switched fabric, when a new device is inserted in the switched fabric, and when an existing device is removed from the switched fabric.

22. The computer readable medium as claimed in claim 19, further causing the system to enable the client to send a VendorGetResp (SetNotificationFilter) message to the interested client upon receipt of a VendorSet (SetNotificationFilter) message from the interested client to confirm receipt of the list of topology changes that the client is interested.

23. The computer readable medium as claimed in claim 19, further causing the system to send a VendorSend (TopologyChangeNotification) message to the interested client after the topology change is determined in the list of topology changes to notify the topology change that occurred, and to acknowledge the topology change notification upon receipt of a VendorSendResp (TopologyChangeNotification) message from the interested client.
